(19) United States
(12) Patent Application Publication
(10) Pub. No.: US 2018/0265709 A1
(43) Pub. Date: Sep. 20, 2018

(54) PIGMENT PARTICLES HAVING A SURFACE COATING AND COATING COMPOSITION COMPRISING SUCH PIGMENT PARTICLES

(71) Applicant: Fraunhofer-Gesellschaft zur Förderung der angewandten Forschung e.V., München (DE)

(72) Inventors: Marc ENTENMANN, Fellbach (DE); Irina ZIHAREVA, Stuttgart (DE); Heinz GREISIGER, Reutlingen (DE); Rita BITZER, Gärtringen (DE); Thadeus SCHAUER, Neuhengstett (DE); Roman MAURER, Stuttgart (DE); Udo STÖCKLEIN, Stuttgart (DE)

(21) Appl. No.: 15/986,281

(22) Filed: May 22, 2018

Related U.S. Application Data
(63) Continuation of application No. PCT/EP2016/078022, filed on Nov. 17, 2016.

(30) Foreign Application Priority Data
Nov. 26, 2015 (DE) 102015120557.2

(51) Int. Cl. C09C 3/12; C09C 1/36; C09C 1/24; C09C 1/30; C09D 7/20; C09D 5/02; C09C 1/00

(52) U.S. Cl. CPC C09C 3/12; C09C 1/3684; C09C 1/24; C09C 1/3081; C09D 7/20; C09C 2200/408; C09C 1/0018; C01P 2004/30; C01P 2004/62; C01P 2004/61; C09D 5/022

(57) ABSTRACT

In order to provide pigment particles and coating compositions comprising them that are suitable for demanding industrial protective coatings and coatings in the automobile sector, a proposal is made for pigment particles having a surface coating for use in a stratifying coating composition, where the surface coating of the pigment particles is formed using an organic, amino-functional component, which in particular has two or more amino groups, and a reactive, silane-functional component different from the aforesaid component.

### CROSS-REFERENCE TO RELATED APPLICATIONS

This patent application is a Continuation of International Patent Application No. PCT/EP2016/078022, filed Nov. 17, 2016, which claims the benefit of German Patent Application No. 10 2015 120 557.2, filed Nov. 26, 2015, which are each incorporated by reference.

### BACKGROUND OF THE INVENTION

The invention relates to pigment particles having a surface coating which are suitable in particular for use in stratifying coating compositions, with which coatings on a substrate can be achieved with a surface-remote, substrate-near concentration of the pigment particles.

The invention relates further to substrates having a coating produced using the aforesaid stratifying coating composition, and also to a method for producing an effect pigment paint coat, utilizing the stratifying properties of the pigment particles of the invention.

Stratifying coating compositions are of great interest industrially and economically, because, with the nowadays customary three- to five-layer coatings for industrial protective coatings, or else with paints used in the automobile sector, there is a relatively high cost efficiency from reduction not only in the number of individual layers to be applied in order to form the complete coating but also in the overall film thickness and hence in the consumption of material.

Known from the two U.S. Patent Applications US 2010/0317787 A1 and US 2011/0028612 A1 are self-stratifying coating compositions which are based on—preferably fluorinated—polyether components, a silsesquioxane as siloxane component, and a polyester polyol.

Known from U.S. Pat. No. 4,654,270 is a self-stratifying coating composition containing polysiloxane components that further comprises a polyester binder and preferably an amino resin as curing agent.

A further stratifying coating composition is known from British Patent Specification GB 631,245, being based on a paraffinic binder, on a polyvinyl binder, formed more particularly from a copolymer of a vinyl halide and vinyl acetate, and on a solvent for these components, and being said also to be suitable for the coating of metals.

Known from U.S. Patent Application US 2004/0127593 A1 is a self-stratifying aqueous coating composition which includes at least two oligomeric or polymeric binders that, following application to the substrate, separate layerwise into different phases as a result of different surface tensions.

The self-stratifying coating compositions recited above are always based on at least two mutually incompatible polymeric or oligomeric components which separate into a near-surface layer and a near-substrate layer, having different physical and chemical properties.

These self-stratifying coating compositions often contain binder mixtures composed of mutually incompatible polymeric or oligomeric, olefinic or paraffinic components, on the one hand, and siloxane or organofluorine components, on the other.

A problem which arises with these systems that form separate layers and that are based on the incompatibility of binder components is the problem in particular of insufficient substrate adhesion and/or interlayer adhesion, with the consequence that these systems are suitable, if at all, only for specialty applications.

For use in the area of industrial protective coatings or of coatings in automobile manufacture they appear to be less well suited, particularly on account of the extensive specification and performance tests that are customary in those areas. This may well also be one reason why the self-stratifying coating compositions described in the prior art have to date found no significant acceptance within the market.

### BRIEF SUMMARY OF THE INVENTION

It is an object of the invention, therefore, to propose pigment particles, and coating compositions comprising them, that are suitable for demanding industrial protective coatings and coatings in the automobile sector.

This object of the invention, in connection with the pigment particles of the invention, is achieved with the features of claim 1.

Stratifying coating compositions of the invention which comprise such pigment particles are defined in claim 10.

The pigment particles of the invention are suitable especially for use in self-stratifying coating compositions wherein the stratification takes the form of a distribution gradient of the components of the composition within a coherent layer, as viewed over the thickness of the coating obtained. In this way, layers within the coating that are distinguishable from one another and hence may also suffer detachment from one another can be avoided. With these self-stratifying coating compositions it is also possible to achieve a coating having very good substrate adhesion such as to satisfy even very exacting requirements. In particular, distribution gradients of the pigment particles of the invention in the coating can also be achieved with increased concentrations in near-substrate and surface-remote regions of the coating, an effect which produces additional advantages across a range of applications.

Reactive silane-functional components in the sense of the present invention are components which comprise a silane compound and are able to enter into a crosslinking reaction with an amino-functional component. The crosslinking reaction in this context is not specific to one particular type of reaction.

Examples of methods suitable for coating the pigment particles of the invention with the surface coating are methods operating on the LCST principle, as is described for example in DE 100 06 538 C2.

Other coating methods suitable for producing the pigment particles of the invention are disclosed in WO 2010/063430 A1, for example.

### BRIEF DESCRIPTION OF THE DRAWINGS

The above-stated aspects and advantages of the invention are elucidated in more detail below by means of the following Examples and Figures.

In detail:

FIG. 1 shows IR-microscopic measurements of near-surface and near-substrate regions of coatings formed from commercially available automotive clearcoats ProGloss, iGloss (both BASF Coatings), and CeramiClear (PPG);

FIG. 2 shows sedimentation analyses for the Iriodin pigment 1103 in MPA, surface-modified according to the prior art (formula B1) and surface-coated according to the invention (formula B3-A1);

FIG. 3 shows sedimentation analyses for the Iriodin pigment 1103 in MPA/solvent naphtha 1:1, surface-modified according to the prior art (formula B1) and surface-coated according to the invention (formula B3-A1);

FIG. 4 shows sedimentation analyses for the Iriodin pigment 1504 in MPA, surface-modified according to the prior art (formula B1) and surface-coated according to the invention (formula B3-A1);

FIG. 5 shows sedimentation analyses for the Iriodin pigment 1504 in MPA/solvent naphtha 1:1, surface-modified according to the prior art (formula B1) and surface-coated according to the invention (formula B3-A1);

FIG. 6 shows the 20° surface gloss as a function of the type of surface modification/coating of the Iriodin 103 and Iriodin 504 pigment particles in the clearcoat formulation A;

FIG. 7 shows the 20° surface gloss as a function of the type of surface modification/coating of the Iriodin 103 and Iriodin 504 pigment particles in the clearcoat formulation B;

FIG. 8 shows a corrosion protection investigation using impedance measurements on the hydrophilic clearcoat formulation B with, respectively, 3 wt % of unmodified and of surface-coated talc pigment particles LP30 according to the invention according to Example 1;

FIG. 9 shows effects of pigment particles Iriodin 103 B4-A4 according to the invention and prior-art pigment particles Iriodin 103 B1 on the du of a guide clearcoat formulation A for different pigment particle concentrations; and

FIG. 10 shows effects of pigment particles Iriodin 103 B4-A4 according to the invention and prior-art pigment particles Iriodin 103 B1 on the DOI of a guide clearcoat formulation A for different pigment concentrations.

### DETAILED DESCRIPTION OF THE INVENTION

With the pigment particles of the invention, the surface coating does not necessarily cover the entire surface of these particles. Nor is it necessary for the thickness of the surface coating to be uniform.

Especially preferred are pigment particles wherein the surface coating covers substantially the entire surface of the pigment particles, with further preference being given to a substantially uniform thickness of the surface coating.

The method of the invention is based on the finding by the inventors that in the case of organic coating formulations which comprise amino-functional curing components, there may be a surface-remote and near-substrate concentration of polar components, more particularly of amino-functional components.

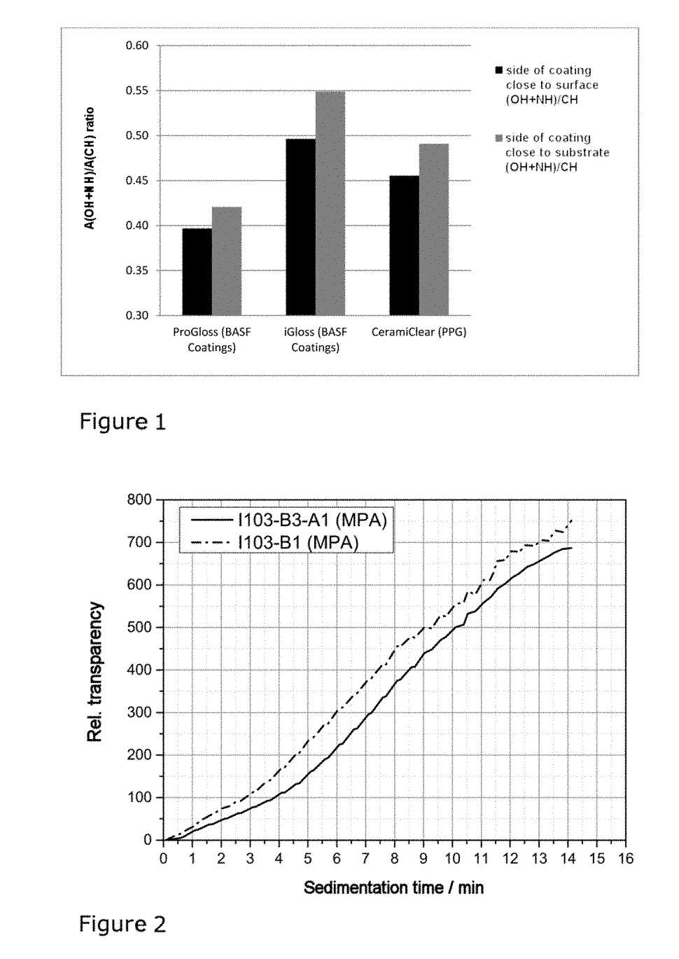

Accordingly, as depicted in FIG. 1, using IR-microscopic comparative measurements, at both the top sides and the bottom sides of coating films detached from a substrate, and, respectively, before detachment of the coating films at their surface and at their near-substrate region, the inventors were able to establish a significant increase in polar, amino-functional and hydroxy-functional coating components at the (formerly) near-substrate side of the coating films, both for commercially available automotive clearcoats ProGloss and iGloss (both BASF Coatings) and for CeramiClear (PPG).

Surprisingly it has now been found that even particles, especially anisotropic and platelet-shaped pigment particles, which have a surface coating based on organic, amino-functional components can be concentrated in surface-remote and near-substrate form in coatings, this phenomenon also being referred to below using the term “stratification”.

Often, in accordance with the invention, for platelet-shaped pigment particles, the stratification additionally produces good orientation and alignment of the platelet-shaped particles parallel to the substrate surface, in the context of the near-substrate concentration.

It has further surprisingly been found that pigment particles surface-coated in accordance with the invention, when added to clearcoat formulations, often increase the viscosity of those formulations less severely than do corresponding pigment particles surface-modified, in accordance with the prior art, only with silane-functional components. This has favorable effects on the flow of the clearcoat formulations on the substrate surface and hence also on the development of a high surface gloss and on the extent of the pigment stratification.

The weight fraction of the surface coating, based on the weight of the uncoated pigment particles, is preferably around 0.3 wt % or more. A preferred upper limit observed is a weight fraction of around 7 wt %, preferably of around 5 wt %. A further-preferred range for the weight fraction of the surface coating based on the weight of the uncoated pigment particles is around 2 to around 3.5 wt %, most preferably around 2.1 to around 3.5 wt %.

The organic, amino-functional component used in forming the surface coating of the pigment particles of the invention comprises preferably an oligomeric, amino-functional polyether, an oligomeric polyethyleneimine, an aliphatic, aromatic and/or heterocyclic amine, or mixtures of two or more of the aforesaid components.

Heterocyclic amines having two or more nitrogen atoms, 1H-benzotriazole for example, qualify for the purposes of the present invention as amino-functional component having two or more amino groups.

Particularly preferred amino-functional components having two or more amino groups are polyoxypropylenediamine, 1,2-diaminocyclohexane, 2,4,6-triaminopyramidine, and 1H-benzotriazole.

Used further preferred as silane-functional component in forming the surface coating of the pigment particles of the invention is a reactive, preferably epoxy- and/or amino-functional silane component. Particularly preferred silane-functional components are N-(2-aminoethyl)-3-aminopropyltrimethoxysilane (DAMO), 3-aminopropyltrimethoxysilane (AMMO), 3-methacryloxypropyltrimethoxysilane (MEMO), and 3-glycidyloxypropyl-trimethoxysilane (GLYMO). The preferred silane-functional components may be employed individually or in mixtures of two or more.

The surface coating of the invention is formed using an amino-functional component and a silane-functional component, where the ratio of the weight fractions of the silane-functional to the amino-functional component in the surface coating of the particles is in particular around 1:2 to around 5.8:1, preferably around 1.2:1 to around 5.8:1, more preferably around 1.5:1 to around 4.8:1, most preferably around 1.8:1 to around 2.8:1.

The use of amino-functional component in excess over the silane-functional component may be advantageous in cases of coating compositions with polar character.

The present invention is suitable for modifying pigment particles of different shapes and sizes, including, in particular, granular and substantially spherical pigment particles.

In order to achieve particular effects in the stratifying of the pigment particles in the surface coating, however, particular preference is given to pigment particles which are three-dimensionally anisotropic, more particularly platelet-shaped pigment particles.

The average particle size D₅₀ of the pigment particles is preferably around 0.1 μm to around 120 μm, more preferably around 1 μm to around 30 μm, the average particle size in the case of three-dimensionally anisotropic particles being determined on the basis of the largest extent of the particles.

As already addressed at the outset, the invention further relates to stratifying coating compositions, more particularly in the form of paint compositions, which comprise a first polar, oligomeric or polymeric component, a fraction of a polar solvent, and a fraction of pigment particles of the invention.

In the coating compositions of the invention, the fraction of the pigment particles, based on the solids which form from the paint composition, is situated more particularly in the range from around 0.05 wt % to around 30 wt %, preferably around 0.1 to around 5 wt %, more preferably around 0.1 wt % to around 1.5 wt %, most preferably around 0.1 to around 0.25 wt %.

In the case of applications in the automobile sector, nonstratifying particles may be used in addition to the stratifying particles in the coating compositions, in which case the fraction of the nonstratifying pigment particles is fairly low, typically around 30 wt % of the fraction of the pigment particles used, or less.

In the sector of industrial paints, the fraction of the nonstratifying particles may be higher, depending on the task at hand, and may amount, for example, to around 30 wt % to around 60 wt % of the fraction of the pigment particles used.

With further preference the coating composition of the invention, at 20° C. and a shear rate of 10 s⁻¹, has a viscosity of around 50 mPas to around 500 mPas, more preferably around 100 mPas to around 400 mPas, most preferably around 100 mPas to around 350 mPas.

These and all further viscosity measurements were carried out using a cone/plate viscometer in accordance with DIN 53019 (model MCR 301/CP50-1 from Anton Paar).

Further preferred are coating compositions with a pronounced thixotropy, for which the difference in the viscosities, determined at 20° C., for shear rates of 10 s⁻¹ and 1000 s⁻¹ is around 300 mPas or less, more preferably around 200 mPas or less, most preferably around 150 mPas or less. For preferred coating compositions, the difference is typically around 20 mPas or more.

The coating composition of the present invention comprises, in particular, one or more volatile solvents selected preferably likewise from polar and nonpolar solvents, the polar solvents being selected more particularly from alcohols, esters, and ketones, and the nonpolar solvents being selected more particularly from hydrocarbons.

Particularly preferred coating compositions of the invention comprise in each case at least one polar solvent and one nonpolar solvent which together form a hydrophobic medium, where the polar solvents are selected in particular from propyl and butyl acetates, and the nonpolar solvents are selected in particular from solvent naphtha (DIN 51 633) (SN), toluene, xylene, and petroleum ether.

Particularly preferred are coating compositions for which all the solvent fractions are selected from volatile solvents.

The coating compositions of the invention can be formulated with great advantages as paint compositions, including in particular in the form of a non-opaque paint, more particularly also as a clearcoat.

The invention further relates to a substrate with a coating produced using one of the coating compositions of the invention.

A preferred feature of substrates of the invention is that on the basis of a stratifying effect, the coating in its surface region, with a thickness corresponding to 25% of the total thickness of the coating, has a fraction of pigment particles which amounts to around 20% or less of the mass of pigment particles in the coating as a whole, preferably around 15 wt % or less, more preferably around 13 wt % or less.

This reduction in the fraction of pigment particles of the invention in the near-surface region of the coating, on the basis of a stratifying effect, means that the fraction of pigment particles in regions of the coating that are adjacent to the substrate surface is above the average pigment particle content.

One of the advantages this procures is that the coating of the invention retains its advantageous properties, in particular the optical properties, but also, for example, the enhanced corrosion resistance, to a significant extent in the event of—possibly also repeated—polishing of the surface, in the course of which considerable fractions of the coating may be removed, whereas with conventional coatings there is a likelihood of significant detriment.

Particularly preferred substrates are those for which the coating has a 20° gloss value, measured according to DIN 67 530/ISO 2813, in the range from around 75 to around 98, more preferably in the range from around 78 to around 95, most preferably in the range from around 80 to around 92.

Further-preferred substrates have a coating in the form of a multilayer coating, where the topmost layer of the coating is produced using the coating composition of the invention.

Mention should further be made of substrates of the invention wherein one of the layers of the multilayer coating beneath the topmost layer is in the form of a primer coat and/or basecoat.

A particularly important field of use of the coating compositions of the invention is in industry, including in particular the automobile industry, where the coating compositions of the invention can in particular also be employed as an alternative to conventional clearcoat formulations for the coating of vehicle bodies.

The invention also relates, lastly, to a method for producing an effect pigment paint coating, in which first a primer coat or basecoat and thereafter a coating composition of the invention are applied to a substrate.

### EXAMPLES

### Example 1

Implementation of surface modifications according to the prior art and the surface coating according to the invention

The surface modifications indicated below were carried out using both effect pigments from Merck, namely Iriodin 103 (titanium dioxide particles with D₅₀≈25 μm) and Iriodin 504 (iron oxide particles with D₅₀≈25 μm), and talc particles LP30 from LITHOS Industrial Minerals GmbH (D₅₀≈9 μm) as pigment particles.

Implementation of Surface Coating of Pigment Particles

100 g of platelet-shaped pigment particles (Iriodin 103 (1103), Iriodin 504 (1504), talc LP30 (LP30)) are dispersed at room temperature in 11 of distilled water, which contains the fraction of the organic, amino-functional component, for 15 minutes with the aid of a stirrer (Dispermat model FKF80L/2T from VMA-Getzmann GmbH) at 0.1 m/s. This mixture is subsequently heated to 70° C. with gentle stirring and the fraction of the reactive, silane-functional component 2-aminoethyl-3-aminopropyltrimethoxysilane (Dynasylan DAMO; Evonik AG) and, optionally, additionally 3-glycidyloxypropyltrimethoxysilane (Dynasylan GLYMO, Evonik AG) is added to the mixture. After 30 minutes of stirring at 70° C., the surface-coated pigment obtained is isolated by filtration and cleaned by repeated rinsing with distilled water. The fractions of the amino-functional and silane-functional components (also called amino component and silane component, respectively, for short) used in the individual example formulas are indicated in Table 1 below.

The example formula defined as B1 in Table 1 below serves as a comparative formula with DAMO as silane-functional component. In this comparative example no amino-functional component is used. The surface modification carried out here corresponds to the prior art (EP 0 492 223 A2).

The example formulas B2-A1 and B3-A1 use surface coatings of the invention employing DAMO as silane component and polyoxypropylenediamine (available as Jeffamine D-400 with a molar mass of around 430 g/mol from Huntsman Corp.) as amino component.

The example formulas B3-A2, B3-A3, and B3-A4 use not only the silane-functional component DAMO but also various further amino-functional components for the surface coating of the invention, these amino components more specifically being as follows:

in example formula B3-A2 1,2-diaminocyclohexane,

in example formula B3-A3 2,4,6-triaminopyramidine, and

in example formula B3-A4 1H-benzotriazole.

In the further example formulas B4-A1, B4-A2, B4-A3, and B4-A4, two silane-functional components, namely DAMO and GLYMO, are used in the surface coating of the pigment particles, while the amino-functional component is varied as follows:

B4-A1 polyoxypropylenediamine (Jeffamine D-400)

B4-A2 1,2-diaminocyclohexane

B4-A3 2,4,6-triaminopyramidine and

B4-A4 1H-benzotriazole.

The fractions of the respective silane-functional and amino-functional components in the formulas used for surface coating are reproduced in Table 1, in each case as wt % based on the amount of uncoated pigment particles.

TABLE 1
Surface modifications according to the prior art, and surface coatings
of pigment particles according to the invention

| | Example | | | | | | | | | |
|---|---|---|---|---|---|---|---|---|---|---|
| | | B2- | B3- | B3- | B3- | B3- | B4- | B4- | B4- | B4- |
| Component | B1 | A1 | A1 | A2 | A3 | A4 | A1 | A2 | A3 | A4 |
| Amino component | — | 1 | 1 | — | — | — | 1 | — | — | — |
| Jeffamine D-400 | | | | | | | | | | |
| Amino component | — | — | — | 1 | — | — | | 1 | — | — |
| 1,2-diaminocyclohexane | | | | | | | | | | |
| Amino component | — | — | — | — | 1 | — | | — | 1 | — |
| 2,4,6-triaminopyramidine | | | | | | | | | | |
| Amino component | — | — | — | — | — | 1 | | | — | 1 |
| 1H-benzotriazole | | | | | | | | | | |
| Silane component | 3.5 | 1 | 2.5 | 2.5 | 2.5 | 2.5 | 0.9 | 0.9 | 0.9 | 0.9 |
| DAMO | | | | | | | | | | |
| Silane component | — | — | — | — | — | — | 1.6 | 1.6 | 1.6 | 1.6 |
| GLYMO | | | | | | | | | | |

For the surface coating according to formula B2-A1, a low concentration initially, and in formula B3-A1 a higher concentration, of the silane-functional component was selected, for a constant fraction of the organic amino-functional component, in order to show the relationship between the surface coating of the invention and the concentration of the silane-functional component.

In view of the overall relatively small amount of amino-functional and silane-functional components, the formula B2-A1 is less well suited particularly to the surface coating of fine pigment particles with high particle surface areas.

### Example 2

Characterization of compatibility of pigments obtained from Example 1 by sedimentation analyses in a methoxypropyl acetate/solvent naphtha solvent mixture and in pure MPA

To characterize the compatibility of the pigment particles I103-B1 and I504-B1, surface-modified in accordance with the prior art, and of the pigment particles I103-B3-A1 and I504-B3-A1 surface-coated in accordance with the invention, sedimentation analyses were conducted in the polar solvent methoxypropyl acetate (MPA) and in a 1:1 solvent mixture of MPA/SN made more hydrophobic by the addition of solvent naphtha (SN). The sedimentation analyses include transparency measurements as a function of sedimentation time. The amount of pigment particles selected in each case was 0.09 wt %, based on the solvent.

A sharp increase in the transparency in relation to the sedimentation time here marks a relatively low wetting and compatibility of the respective surface-modified/surface-coated pigment particles with the respective solvent or solvent mixture.

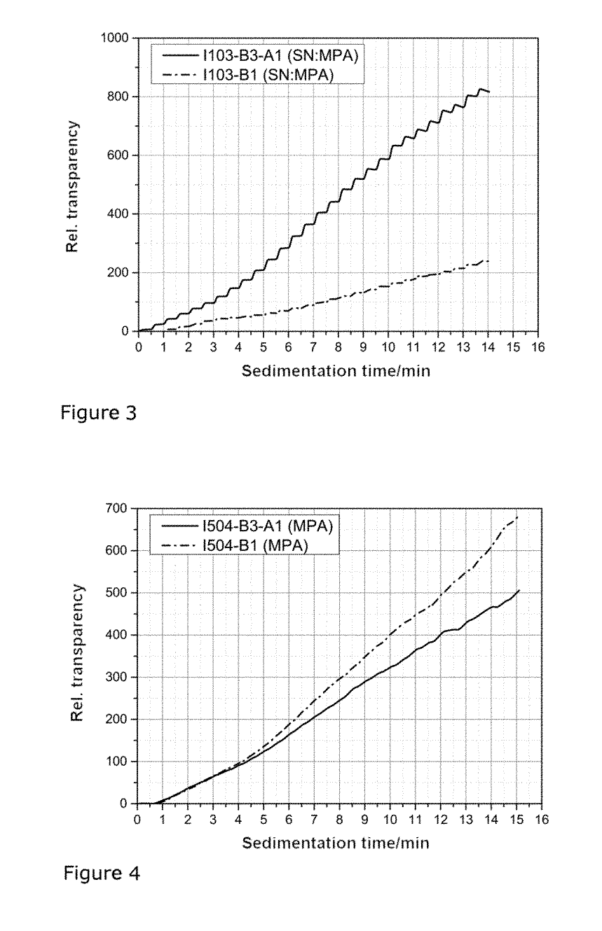

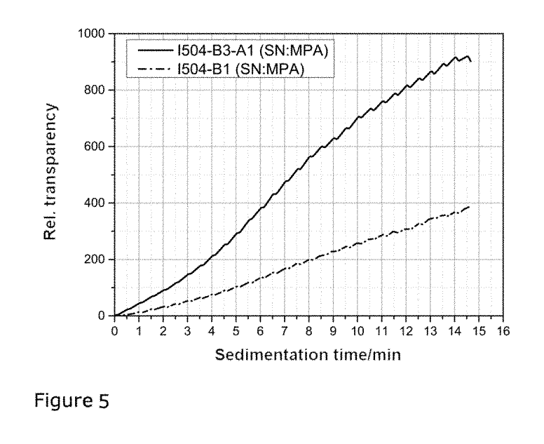

The results of the sedimentation analyses are represented comparatively in the diagrams of FIGS. 2 to 5, for Iriodin pigments 1103 and 1504, surface-modified according to the prior art (formula B1), and also surface-coated in accordance with the invention additionally using the polyfunctional organic amino component Jeffamine D-400 (formula B3-A1).

It can be seen that the Iriodin pigment particles based on Iriodin 103 and Iriodin 504 with the surface coating in accordance with the invention of formula B3-A1 exhibit somewhat improved compatibilization and flocculation stability in the more strongly polar solvent MPA than do pigment particles with the surface modification according to the prior art (formula B1), modified only with the silane-functional component. In the more hydrophobic solvent mixture with solvent naphtha, conversely, there is an opposite effect observable on the sedimentation behavior of the pigment particles.

These results show that by virtue of the excellent wetting and flocculation stability, pigment particles surface-coated in accordance with the invention are suitable especially for use in coating compositions with high fractions of polar solvents.

### Example 3

Incorporation of pigment particles from Example 1 into guide clearcoat formulations and characterization of the resultant stratification effect through measurement of the surface gloss

Mixed as guide clearcoat formulations were the guide formula A listed below, with methoxypropyl acetate (MPA)/solvent naphtha (SN) in a ratio of 1:1, and the guide formula B listed below, exclusively with MPA, adapted from the guide formula RR 4210 for a 2-component PU clearcoat, chemically resistant, from Covestro AG (formerly Bayer MaterialScience AG):

Guide clearcoat formulation A

| | | |
|---|---|---|
| 50.30 | wt % | Desmophen ® A 665 BA/X, 65 wt % in butyl |
| | | acetate/xylene |
| 0.50 | wt % | Baysilone ® coatings additive OL 17, 10 wt % in MPA |
| 0.50 | wt % | Modaflow ®, 1 wt % in MPA |
| 4.97 | wt % | Tinuvin ® 292, 10 wt % in MPA |
| 7.46 | wt % | Tinuvin ® 400, 10 wt % in MPA |
| 17.38 | wt % | 1-methoxy-2-propyl acetate (MPA)/solvent naphtha (1:1) |
| 18.89 | wt % | Desmodur ® N 3390 BA, 90 wt % in butyl acetate |

Fractions of pigment particles from Example 1 which are specified below in each case, the fractions being based on the solids formed from Desmodur® and Desmophen®.

At a temperature of 20° C., the guide clearcoat formulation A has a viscosity of 320 mPas at a shear rate of 10 s⁻¹ and a viscosity of 319 mPas at a shear rate of 1000 s⁻¹.

Guide clearcoat formulation B

| | | |
|---|---|---|
| 50.31 | wt % | Desmophen ® A 665 BA/X, 65 wt % in butyl |
| | | acetate/xylene |
| 0.50 | wt % | Baysilone ® coatings additive OL 17, 10 wt % in MPA |
| 0.50 | wt % | Modaflow ®, 1 wt % in MPA |
| 4.97 | wt % | Tinuvin ® 292, 10 wt % in MPA |
| 7.46 | wt % | Tinuvin ® 400, 10 wt % in MPA |
| 17.38 | wt % | 1-methoxyprop-2-yl acetate (MPA) |
| 18.89 | wt % | Desmodur ® N 3390 BA, 90 wt % in butyl acetate |

Fractions of pigment particles from Example 1 which are specified below in each case are based on the solids formed from Desmodur® and Desmophen®.

At a temperature of 20° C., the guide clearcoat formulation B has a viscosity of 331 mPas at a shear rate of 10 s⁻¹ and a viscosity of 330 mPas at a shear rate of 1000 s⁻¹.

The viscosity differences for the two guide clearcoat formulations A and B at the different shear rates are small. In industrial practice, however, paint compositions are frequently used wherein the thixotropic properties are more strongly pronounced.

Of the two above-defined guide clearcoat formulations, guide clearcoat formulation A (with solvent mixture MPA/SN in a ratio of 1:1) is the less polar, and guide clearcoat formulation B (with solvent MPA) the more strongly polar formulation.

The clearcoat formulations with the differently surface-modified or surface-coated pigment particles were applied pneumatically with a dry film thickness of around 35 μm to black Leneta panels (manufacturer: Leneta Company Inc.).

For high-gloss coatings with pigment particle contents that are not too high, it can be assumed that a very largely surface-remote and more near-substrate disposition of the pigment particles in the dry paint film is beneficial to maximum surface gloss values. This assumption was verified qualitatively and quantitatively using individual laser scanning microscopy images and also SEM cross-section images.

Using the example of a coating on a substrate (black Leneta panel), it was possible with a laser scanning microscope (model VK-X from Keyence Corp.) to show that Iriodin pigment particles 1103 B3-A1 from Example 1 coated in accordance with the invention, in a 40 μm coating with a pigment content of around 1 wt %, based on the solids content of the coating material, in a composition based on the paint formula B, are detectable only with a fraction of around 12% in the near-surface 10 μm, owing to the stratification effect achieved in accordance with the invention, instead of the statistical figure of 25%, whereas the same pigment in uncoated form in fact accumulates to an extent of around 32% in this near-surface region.

The viscosity values of the guide clearcoat formulation B remain substantially unchanged within the bounds of measurement accuracy after addition of the pigment particles 1103 B3-A1 with a fraction of 1 wt %.

The advantage of the stratification effect is that substrates coated in accordance with the invention, even after surface polishing entailing removal of one quarter of the coating, are present in substantially unchanged form in terms of their properties, including in particular their optical properties, whereas for a coating with untreated pigment it is necessary to accept significant detriment in terms of the optical properties. After such polishing in the case of a coating in accordance with the invention, the corrosion resistance as well is substantially retained, whereas with coatings with untreated pigments a considerable deterioration is likely. A further factor in the context of the corrosion resistance is that not only is the near-surface region of the coatings depleted of pigments, owing to the stratification effect, but also that in the near-substrate region of the coatings there is a concentration of the pigment particles of the invention beyond the statistical figure.

A further practically relevant measure of the quantification of the resultant stratification of the pigment particle fractions in the coating composition was the 20° surface gloss according to DIN 67 530/ISO 2813.

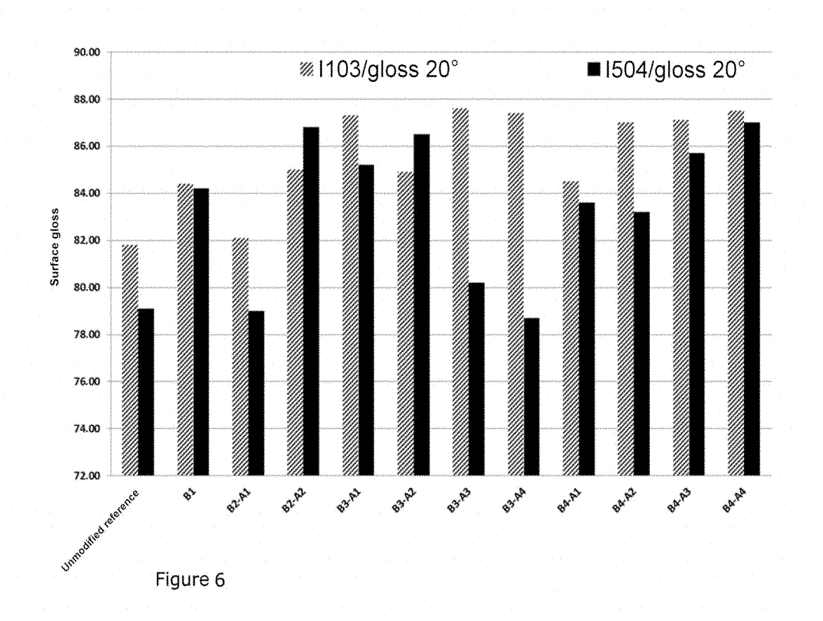

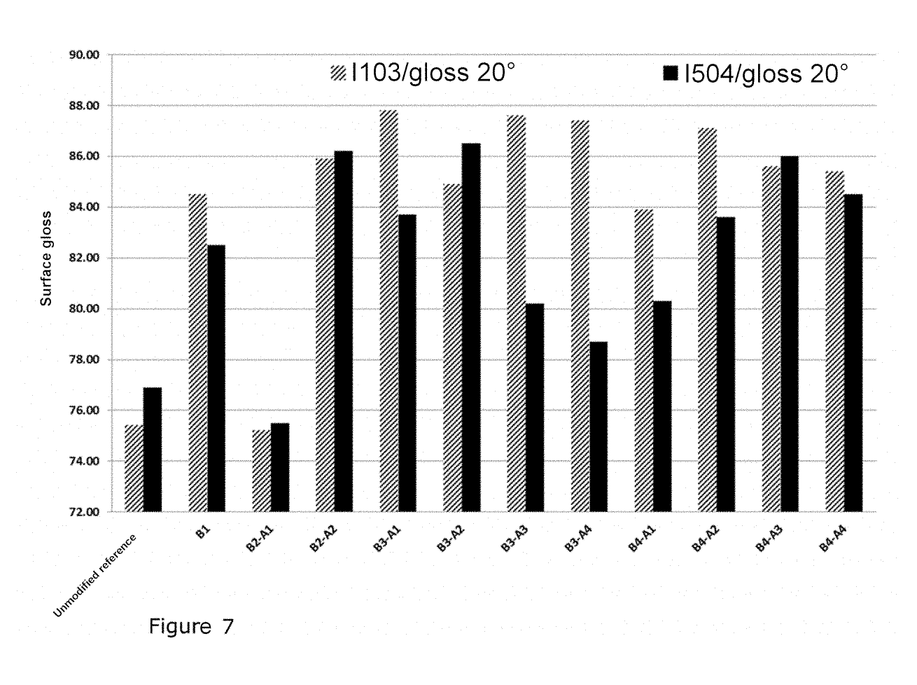

The results obtained are shown both for the more weakly polar clearcoat formulation A with the 1:1 MPA/SN solvent mixture, in FIG. 6, and for the more strongly polar guide clearcoat formulation B with MPA solvent, in FIG. 7, for an amount of 3 wt % in each case of the differently surface-modified/surface-coated Iriodin pigments Iriodin 103 and Iriodin 504 from Example 1.

The viscosity of the coating composition with the pigment particles 1103 B3-A1 at 20° C. and a shear rate of 10 s⁻¹ was 336 mPas. The viscosity measured at 20° C. and a shear rate of 1000 s⁻¹ was 335 mPas.

For the compositions with pigment particles according to the prior art, 1103 B1, viscosity figures found at 20° C. were 341 mPas and 340 mPas at shear rates of 10 s⁻¹ and 1000 s⁻¹ respectively.

The paint compositions used in industrial practice often display much higher differences in the viscosities at the different shear rates.

The results in FIGS. 6 and 7 clearly suggest that the maximum surface gloss values which develop are dependent on the nature of the surface modification/coating, on the base pigment used, and also, substantially, on the polarity of the solvent components in the clearcoat formulations.

This is also confirmed by the finding of the sedimentation investigations from Example 2, which showed that the wetting and the flocculation stability of the pigment particles are dependent on the surface modification/coating, on the nature of the pigment particles used, and also, substantially, on the polarity of the solvent/solvent mixture used.

If, then, it is assumed that in the copolymerization of multiply amino-functional component(s) of low molecular mass, there are significant increases in the amino functionality and in the polarity of the pigment surface coating, and that higher fractions of the silane-functional component(s) in the surface coating of the invention on the pigment particles tend to impact deleteriously on the pigment wetting and flocculation stability, the sedimentation results in Example 2 and the surface gloss values obtained in Example 3 may be interpreted as showing that a more highly amino-functional surface coating is beneficial to the wetting of pigment particles and also enables the attainment of high surface gloss values, relative to the exclusive use of silane-functional components as in the prior art.

An increase in the surface gloss or a relatively surface-remote concentration of the pigment particles of the invention can also be reconciled with the significant increase found by the inventors for amino-functional clearcoat systems, in polar, amino-functional and hydroxy-functional paint components at near-substrate regions of the coating (cf. FIG. 1).

The differences appearing in FIGS. 6 and 7 between the formulas B2-A1 and B3-A1 reflect the influence of the amount of silane-functional component in the surface coating of the pigment particles.

The inventors assume that the silane-functional component predominantly takes on the function of fixing the reaction product of the organic amino-functional component with the silane-functional component on the pigment particle surface, since only in that case are correspondingly high surface gloss values achieved, unless the amount of silane-functional component falls below a critical amount that is needed for crosslinking.

Furthermore, in the case of the formula B2-A1, use was made not only of the highest fractions of the silane-functional component but also, at the same time, of the smallest overall amounts of components for the surface coating, and so ultimately both factors stated share responsibility for the lower gloss values obtained in the case of formula B2-A1.

For fine pigment particles with a relatively high specific surface area, such as platelet-shaped effect pigments, for example, it is therefore preferable to use larger amounts of silane-functional component, based on the pigment particle mass, for the surface coating of such particles, more particularly around 2.0 wt % or more.

It is further apparent in the case of the formulas B4, where a part of the amino-functional silane component has been replaced by an epoxy-functional silane component, that the silane-functional component evidently substantially has the role of the crosslinking partner in the surface coating of the pigment particles and enjoys less of a supporting role in the extent of a high surface gloss in the substrate coatings. With these examples it is also evident, therefore, that the extent of a very high surface gloss is achievable in particular through the organic polyfunctional amino component used.

The picture which then arises, in greatly simplified form, is as follows: pigment particles which have a polar and strongly amino-functional surface coating accumulate to a greater extent at a greater distance from the surface, during paint application to a substrate surface and subsequent flow, than do pigment particles surface-modified conventionally—that is, with exclusive use of silane-functional components.

Comparing the results in FIGS. 6 and 7 for the Iriodin 103 titanium dioxide pigment particles with the corresponding results for the Iriodin 504 iron oxide pigment particles, it is often the more strongly polar Iriodin 103 pigment particles that display the higher surface gloss values. In relation to the base pigment as well, therefore, a higher polarity appears to promote the development of a high surface gloss value.

The effect of the polarity of the solvent mixtures used on the development of the surface gloss in FIGS. 6 and 7 appears by contrast to be relatively small. With isolated exceptions, the trends for development of the surface gloss values are similar for both of the clearcoat formulations used, A and B.

If pigment contents are suitable and sufficiently high, and if the viscosity of the formulated clearcoat systems is not too great and not too weak, in the range from around 50 mPas to around 500 mPas, for example, measured at a shear rate of 10 s⁻¹, it was additionally possible to determine a trend for the lowering of the viscosity at defined shear rates for the surface-coated pigment particles of the invention relative to the pigment particles surface-modified conventionally with exclusive use of silane-functional components.

In many cases, the unpigmented paint formulations display the lowest viscosities, and the corresponding paint formulations with the conventionally surface-modified pigment particles display the highest. The pigment particles surface-coated in accordance with the invention, in contrast, have a viscosity lying between the two extremes.

The surface coating in accordance with the invention of the pigment particles therefore still additionally has a favorable effect on the flow of pigmented paint formulations, which also influences the stratification of the fractions of the pigment particles in the coating composition of the invention, and the characteristic of a high surface gloss value.

### Example 4

Incorporation of talc pigment particles according to the invention obtained from Example 1 into a guide clearcoat formulation, and characterization of the resultant corrosion protection effects by impedance measurements

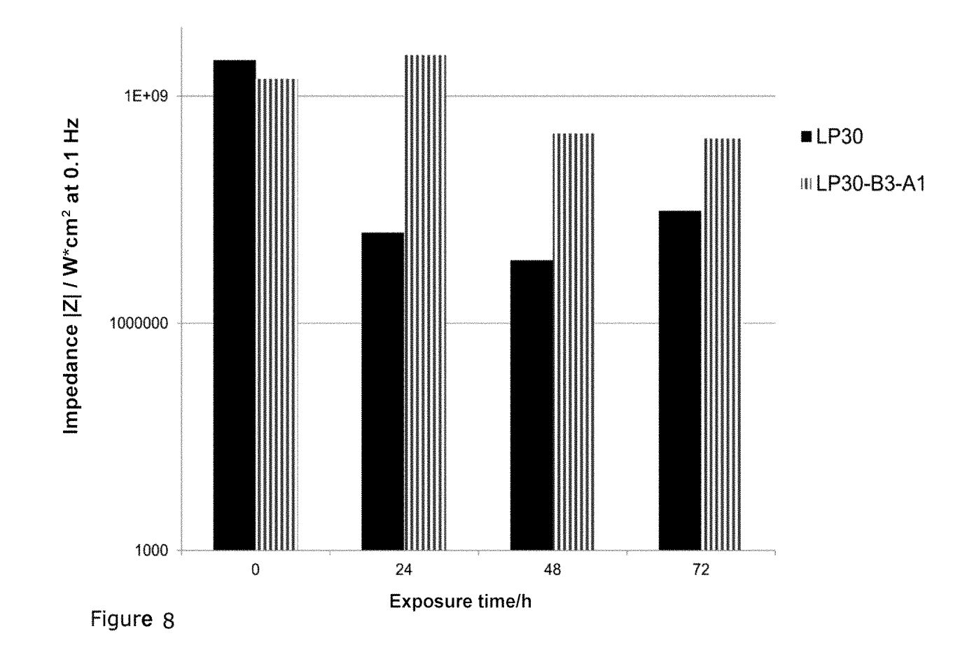

FIG. 8 shows the results of a corrosion protection investigation using impedance measurements on the hydrophilic clearcoat formulation B with MPA as solvent following incorporation of in each case 3 wt % of differently surface-modified talc pigment particles LP30, applied at a dry film thickness of around 35 μm to sandblasted steel panels 200 mm×100 mm×2.0 mm DC 04 B Rz 20-30 μm (Franz Kruppel Industriebedarf, GmbH+Co.KG).

The samples were exposed to a 5 wt % strength aqueous sodium chloride solution for the duration indicated on the abscissa in FIG. 8, with thermal cycling in the form of directly successive one-hour cycles of 23° C. to 70° C. Each cycle comprised heating from 23° C. to 70° C. over half an hour, followed immediately by cooling from 70° C. back to 23° C.

The results reproduced in FIG. 8 show that the more strongly polar and more hydrophilic clearcoat formulation B with MPA and the talc pigment particles (LP30) having the surface coating according to the invention and in accordance with formula B3-A1 exhibits strongly improved corrosion protection properties by comparison with a formulation having non-surface-modified talc of the kind customary in the prior art. Evidently in this case the stratification of the fractions of the pigment particles according to the invention in the paint layer and their concentration in the near-substrate region result in the development of a better barrier to water and to oxygen.

### Example 5

Influence of effect pigment particles surface-modified in accordance with the invention from Example 1 at different concentrations in guide clearcoat formulations on the dullness du and on the Distinctness of Image DOI

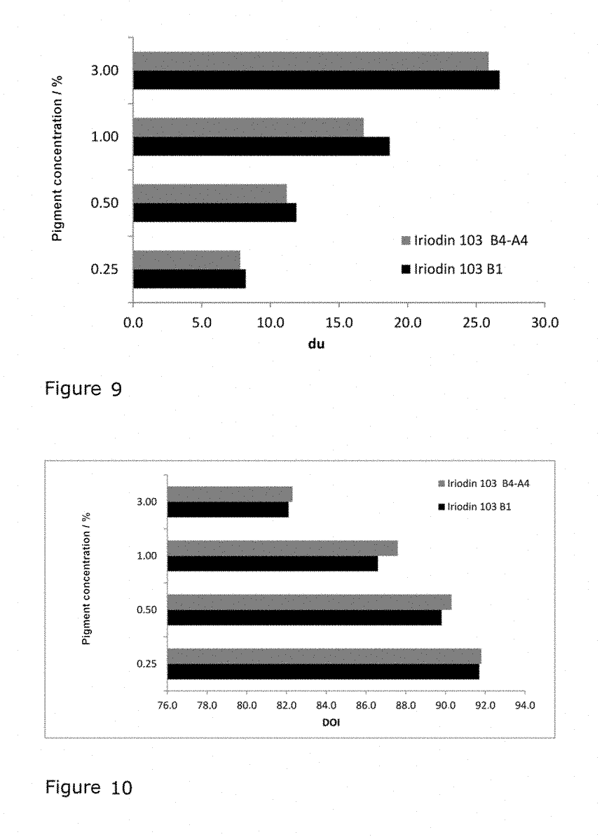

FIG. 9 shows the effects of selected pigment particles surface-coated in accordance with the invention Iriodin 103 B4-A4 and Iriodin 103 B1 according to the prior art from Example 1 on the dullness du, significant in the automobile sector, for the more weakly polar guide clearcoat formulation A, with a 1:1 MPA/solvent naphtha solvent mixture, for the pigment concentrations of 0.25 wt %; 0.50 wt %, 1.00 wt %, and 3.00 wt %.

A lower value for dullness du represents a higher surface quality of the paint layer. In terms of technical measurement, the dullness value du represents the ratio of the scattered light intensity at the edge of a circular aperture to the scattered light intensity in the center of the circular aperture (Konrad Lex, Verlaufsbewertung des Lackaufbaus mit dem wave-scan dual, rl-press, reprint Welt der Farben, 3, 2006, 14-19).

From the results shown in FIG. 9 it is clearly apparent that the dullness du values for pigmented guide clearcoat formulations are more favorable, i.e., lower, for the Iriodin 103 pigment particles surface-coated in accordance with the invention of formula B4-A4 in comparison to an Iriodin 103 B1 pigment surface-modified according to the prior art.

The differences in the du values are additionally influenced greatly by the level of the fractions of the pigment particles. At low pigment concentrations of 0.25 wt %, the differences in relation to the dullness du values between the formulations with pigment particles surface-coated in accordance with the invention and pigment particles surface-modified according to the prior art are much smaller.

FIG. 10 shows the effects of the pigment particles Iriodin 103 B4-A4 according to the invention and the prior-art pigment particles Iriodin 103 B1 from Example 1 on the values for Distinctness of Image DOI (ASTM E 284), which is likewise significant in the automobile sector, for the more weakly polar guide clearcoat formulation A with a 1:1 MPA/SN solvent mixture for the pigment concentrations of 0.25 wt %; 0.50 wt %, 1.00 wt %, and 3.00 wt %. In contrast to the du values, a higher value for DOI represents a greater surface quality of the paint coat.

Looking at the results in FIG. 10, it is clearly apparent that more favorable DOI values, i.e., higher DOI values, are obtained for pigmented guide clearcoat formulations, when using the formula B4-A4 for the pigment particles Iriodin 103 surface-coated in accordance with the invention by comparison with Iriodin 103 B1 pigment particles surface-modified according to the prior art. For concentrations of the pigment particles in the formulations in the range from 0.5 wt % to 1 wt %, the greatest differences in terms of the DOI are between the pigment particles surface-coated in accordance with invention and the pigment particles surface-modified according to the prior art.

Overall, Examples 2 to 5 show that by means of the surface coating in accordance with the invention and according to Example 1 it is possible to optimize different pigment particles for a variety of end uses in different paint systems specifically in relation to optimum wetting, compatibility, and flocculation stability.

It is additionally evident that through the use of pigment particles surface-coated in accordance with the invention in paint systems that are likewise amino-functional and have low levels of pigmentation, it becomes possible to form an extremely coherent near-surface, virtually pigment-free paint layer region.

1. Pigment particles having a surface coating for use in a stratifying coating composition, wherein the surface coating of the pigment particles is formed using an organic, amino-functional component and a reactive, silane-functional component different from the organic, amino-functional component.

2. The pigment particles as claimed in claim 1, wherein the surface coating has a weight fraction, and the uncoated pigment has a weight and the weight fraction of the surface coating is around 0.3 wt % to around 7 wt % of the weight of the uncoated pigment particles.

3. The pigment particles as claimed in claim 1, wherein the organic amino component comprises an oligomeric, amino-functional polyether, an oligomeric polyethyleneimine, an aliphatic, aromatic and/or heterocyclic amine, or mixtures of two or more of the organic amino components.

4. The pigment particles as claimed in claim 1, wherein the silane-functional component comprises an acryl-, epoxy- and/or amino-functional, silane-functional component.

5. The pigment particles as claimed in claim 4, wherein the organic amino-functional component is selected from polyoxypropylenediamine, 1,2-diaminocyclohexane, 2,4,6-triaminopyramidine, and 1H-benzotriazole.

6. The pigment particles as claimed in claim 4, wherein the reactive silane-functional component is selected from N-(2-aminoethyl)-3-aminopropyltrimethoxysilane, 3-aminopropyltrimethoxysilane, 3-methacryloxypropyltrimethoxysilane and/or 3-glycidyloxypropyltrimethoxysilane.

7. The pigment particles as claimed in claim 1, wherein the surface coating has a weight ratio of weight fractions of the silane-functional component to amino functional component and the ratio of the weight fractions of the silane-functional to the amino-functional component in the surface coating is around 1:2 to around 5:8:1.

8. The pigment particles as claimed in claim 1, wherein the pigment particles are three-dimensionally anisotropic particles.

9. The pigment particles as claimed in claim 1, wherein the pigment particles have an average particle size D₅₀ and the average particle size D₅₀ of the pigment particles is around 0.1 μm to around 120 μm, the average particle size D₅₀ in the case of anisotropic particles being determined on the basis of the largest extent of the particles.

10. A stratifying coating composition comprising a polar and oligomeric or polymeric coating component, a fraction of a polar solvent, and a fraction of pigment particles as claimed in claim 1.

11. The coating composition as claimed in claim 10, wherein the fraction of pigment particles in the coating composition is around 0.05 wt % to around 30 wt %, based in each case on a solids content of the coating composition.

12. The coating composition as claimed in claim 10, wherein at 20° C. and a shear rate of 10 s⁻¹ the coating composition has a viscosity of around 50 mPas to around 500 mPas.

13. The coating composition as claimed in claim 10, wherein a difference in viscosities of the coating composition, determined in each case at 20° C., for shear rates of 10 s⁻¹ and 1000 s⁻¹ is around 300 mPas or less.

14. The coating composition as claimed in claim 10, wherein the coating composition contains one or more volatile solvents.

15. The coating composition as claimed in claim 14, wherein the coating composition contains at least one polar solvent and one nonpolar solvent which together form a hydrophobic medium.

16. The coating composition as claimed in claim 10, wherein the coating composition is formulated as a paint composition.

17. A substrate having a coating produced using a coating composition as claimed in claim 10.

18. The substrate as claimed in claim 17, wherein the coating in a surface region, with a thickness corresponding to 25% of the total thickness of the coating, has a fraction of coated pigment particles which amounts to around 20% or less of the mass of pigment particles in the coating as a whole.

19. The substrate as claimed in claim 17, wherein the coating of the substrate has a 20° surface gloss value (measured according to DIN 67 530/ISO 2813) in the range from around 75 to around 98.

20. The substrate as claimed in claim 17, wherein the coating is in the form of a multilayer coating, the topmost layer of the coating being produced using the coating composition.

21. The substrate as claimed in claim 20, wherein one of the layers of the multilayer coating beneath the topmost layer is in the form of a basecoat or primer coat.

22. A method for producing an effect pigment paint coating, the method comprising applying the coating composition as claimed in claim 10 to a substrate having a primer coat and/or basecoat.
